(19) United States
(12) Patent Application Publication
(10) Pub. No.: US 2009/0125754 A1
(43) Pub. Date: May 14, 2009

(54) APPARATUS, SYSTEM, AND METHOD FOR IMPROVING SYSTEM RELIABILITY BY MANAGING SWITCHED DRIVE NETWORKS

(76) Inventors: Rashmi Chandra, San Jose, CA (US); Roah Jishi, Tempe, AZ (US); David Ray Kahler, Tucson, AZ (US); David Lawrence Leskovec, Cervallis, OR (US); Tram Thi Mai Nguyen, San Jose, CA (US); Marc Thadeus Roskow, Los Gatos, CA (US); Steven Richard Van Gundy, Gilroy, CA (US)

Correspondence Address: Kunzler & McKenzie, 8 EAST BROADWAY, SUITE 600, SALT LAKE CITY, UT, 84111, US

(21) Appl. No.: 11/937,404

(22) Filed: Nov. 8, 2007

(51) Int. Cl. G06F 11/20

(52) U.S. Cl. 714/7; 714/E11.089

(57) ABSTRACT

An apparatus, system, and method are disclosed for improving system reliability by managing switched drive networks. An off-network pool of storage devices is logically isolated from an array of storage devices. A detection module detects a failed storage device. A repositioning module logically repositions storage devices that are not performing operations. A rebuilding module may rebuild data from the failed storage device.

### FIELD OF THE INVENTION

This invention relates to switched drive networks and more particularly relates to improving system reliability by managing switched drive networks.

### DESCRIPTION OF THE RELATED ART

Mission critical data is often stored on storage devices such as hard-disk drives. For example, a storage system may include two hard-disk drives. Each hard-disk drive may be configured to store the same data. Thus if a first hard-disk drive failed, a second hard-disk drive could continue providing the data.

Some hard-disk drives may fail and the second hard-disk drive must be activated as the primary drive. For example, a controller may recognize that the first hard-disk drive is failing so it initiates using the back-up hard-disk drive.

Hard-disk drives that have failed are removed from the active network in order to maintain the integrity of the data. If a hard-disk drive may fail, the second hard-disk drive may be repositioned to the active interface.

Unfortunately, it may be difficult to determine a failed drive has been removed from the active interface. As a result, the first hard-disk drive may still be connected to the active interface interfering with the active drives and destabilizing the network.

### SUMMARY OF THE INVENTION

From the foregoing discussion, there is a need for an apparatus, system, and method that improves system reliability by managing switched drive networks. Beneficially, such an apparatus, system, and method would remove and replace failing storage devices without interruption to the storage device network.

The present invention has been developed in response to the present state of the art, and in particular, in response to the problems and needs in the art that have not yet been fully solved by currently available switched drive network management methods. Accordingly, the present invention has been developed to provide an apparatus, system, and method for improving system reliability by managing switched drive networks that overcome many or all of the above-discussed shortcomings in the art.

The apparatus to manage switched drive networks is provided with a plurality of devices and modules configured to functionally execute the steps of storing data on a device, detecting a failed device, repositioning a failed device to a logically fenced area, and rebuilding a device with data from the failing device. These devices and modules in the described embodiments include an off-network pool of storage devices, a detection module, and a repositioning module. The apparatus may also include a rebuilding module.

The off-network pool of storage devices is logically isolated from an array of storage devices. The storage devices may store data. The detection module detects a failed storage device in an array of storage devices. The repositioning module logically repositions the failed storage device from the array, if a remedial operation is not in progress, to the off-network pool wherein the failed storage device is not accessible to the array and data of the failed storage device is accessible to the controller; and logically repositions a replacement storage device from the off-network pool to the array. In one embodiment, the rebuilding module rebuilds the data from the failed storage device. The controller may initiate rewriting the data to a replacement storage device.

A system of the present invention is also presented to manage switched drive networks. The system may be embodied in a data processing system. In particular, the system, in one embodiment, includes an active pool and an off network pool.

The active pool includes a controller and an active array of storage devices. The off-network pool includes a plurality of off-network of storage devices and a logically fenced area for failed storage devices.

The controller communicates with active array of storage devices and the off-network plurality of storage devices. The controller includes a detection module, a repositioning module and a rebuilding module.

The detection module detects a failed storage device in the active array of storage devices. The repositioning module logically repositions the failed storage device to a logically fenced area for failed storage devices if a remedial operation is not in progress, and logically repositions an off-network storage device to the active pool. The rebuilding module rebuilds the data from the failed storage device by initiating rewriting the data to a replacement storage device. The system manages switched drive networks, detecting, repositioning and rebuilding failed drives without interrupting the network.

A method of the present invention is also presented for managing switched drive networks. The method in the disclosed embodiments substantially includes the steps to carry out the functions presented above with respect to the operation of the described apparatus and system. In one embodiment, the method includes detecting the failed storage devices, repositioning the failed and the off-network storage devices. The method also may include rebuilding the failed storage device.

A detection module detects a failed storage device in the active array of storage devices. A repositioning module logically repositions the failed storage device to a logically fenced area for failed storage devices if a remedial operation is not in progress, and logically repositions an off-network storage device to the active pool. A rebuilding module rebuilds the data from the failed storage device by initiating rewriting the data to a replacement storage device. The method manages switched drive networks, detecting, repositioning and rebuilding failed drives without interrupting the network.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention manages switched drive networks. In addition, the present invention may manage the switched drive networks without interrupting the active drive network. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a storage system in accordance with the present invention;

FIG. 2 is a schematic block diagram illustrating one embodiment of a system reliability apparatus of the present invention;

FIGS. 3A and 3B are schematic block diagrams illustrating one embodiment of a switched drive network of the present invention;

FIG. 4 is a schematic flow chart diagram illustrating one embodiment of a switched drive method of the present invention;

FIGS. 5A and 5B are schematic flow chart diagrams illustrating one embodiment of a controller communication method of the present invention;

FIGS. 6A and 6B are schematic block diagrams illustrating one embodiment of a storage capacity upgrade of the present invention;

FIG. 7 is a schematic block diagram illustrating one embodiment of an off-network pool controller of the present invention; and

FIG. 8 is a schematic block diagram illustrating one embodiment of a pre-activation diagnostic controller process of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays (FPGAs), programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within the modules, and may be embodied in any suitable form and organized within any suitable type of data structure. The operational data may be collected as a single data set, or may be distributed over different locations including different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

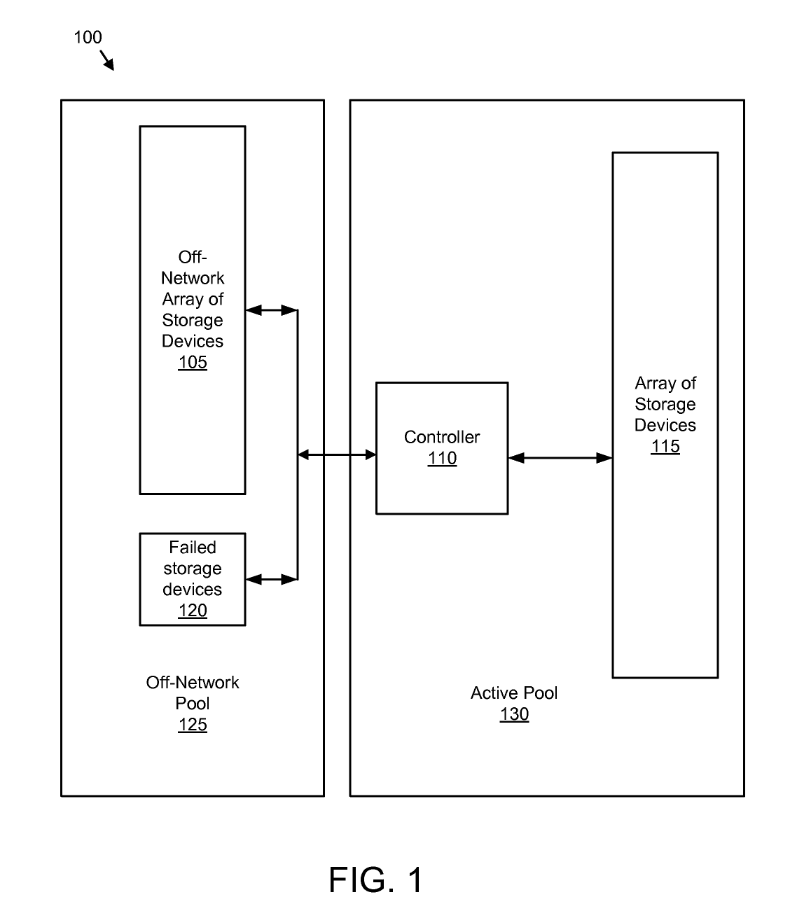

FIG. 1 depicts a schematic block diagram illustrating one embodiment of a storage system 100 in accordance with the present invention. The storage system 100 is comprised of an off-network pool 125 and an active pool 130. The off-network pool 125 has an off-network array of storage devices 105 and a logically fenced area for failed storage devices 120. The active pool has a controller 110 and an array of storage devices 115. The off-network pool 125 of storage devices is logically isolated from the array of storage devices 115.

Although for simplicity, one off-network pool 125, one active pool 130, one off-network array of storage devices 105, one logically fenced area for storage devices 120, one controller 110, and one array of storage devices 115 are shown, any number of off-network pools 125, active pools 130, off-network array of storage devices 105, logically fenced area for storage devices 120, controllers 110, and arrays of storage devices 115, may be employed.

The controller 110 manages the storage system 100 for the off-network pool 125 and the active pool 130. The storage system 100 may include a plurality of hard disk drives, optical storage devices, holographic storage devices, micro-mechanical storage devices, semiconductor storage devices, and the like. The controller 110 may logically isolate the off-network pool 125 from the active pool 130.

The off-network array of storage devices 105 may be initially installed, configured, tested and logically off the network from the array of storage devices 115. The off-network array of storage devices 105 may be inactive and not store data until directed to do so by the controller 110. Likewise, the logically fenced area for storage devices 120 may be inactive but have stored information from previously being in the active pool 130. The array of storage devices 115 may be active and storing data as directed by the controller 110. For example, the controller 110 may evaluate the status of the array of storage devices 115 and find that all are working. The controller will not logically reposition any storage device because all are working as designed.

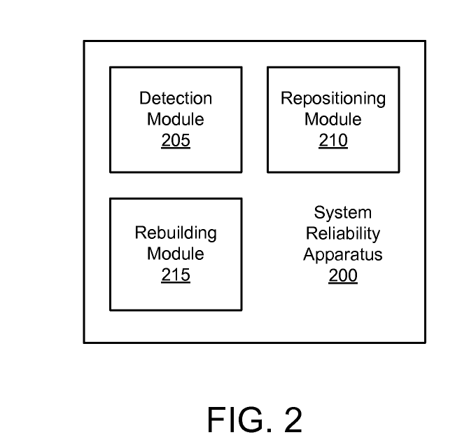

FIG. 2 depicts a schematic block diagram illustrating one embodiment of a system reliability apparatus 200 of the present invention. The apparatus 200 maintains system reliability and can be embodied in the storage system 100 of FIG. 1, like numbers referring to like elements. The apparatus 200, which may operate on the controller 110, includes a detection module 205, a repositioning module 210, and a rebuilding module 215. The detection module 205, repositioning module 210, and rebuilding module 215 may comprise one or more computer readable programs executing on the controller 110.

The detection module 205 detects a failed storage device in the array of storage devices 115. For example, the detection module 205 may receive a command from the computer program operating on the controller 110 to perform a diagnostic test on the array of storage devices 115. The detection module 205 may detect that a storage device has an unrecoverable redundant error code and marks it as a failed storage device.

The repositioning module 210 logically repositions a storage device. For example, the repositioning module 210 may logically reposition a failed storage device in the array of storage devices 115 to the off-network pool 125 and more particularly to the logically fenced area for storage devices 120, if a remedial operation is not in progress.

In another embodiment, the repositioning module may logically reposition a replacement storage device from the off-network pool 125 to the active pool 130. For example, the detection module 205 may detect that the active pool 130 does not have the required amount of storage initially established. The repositioning module 210 repositions one of the storage devices from the off-network array of storage devices 105 to the active pool 130.

The rebuilding module 215 rebuilds the data from a failed storage device wherein the controller 110 initiates rewriting the data to a replacement storage device. For example, the rebuilding module 215 may initiate rewriting the data from a failed storage device which may have a critical database of customer information to a replacement storage device.

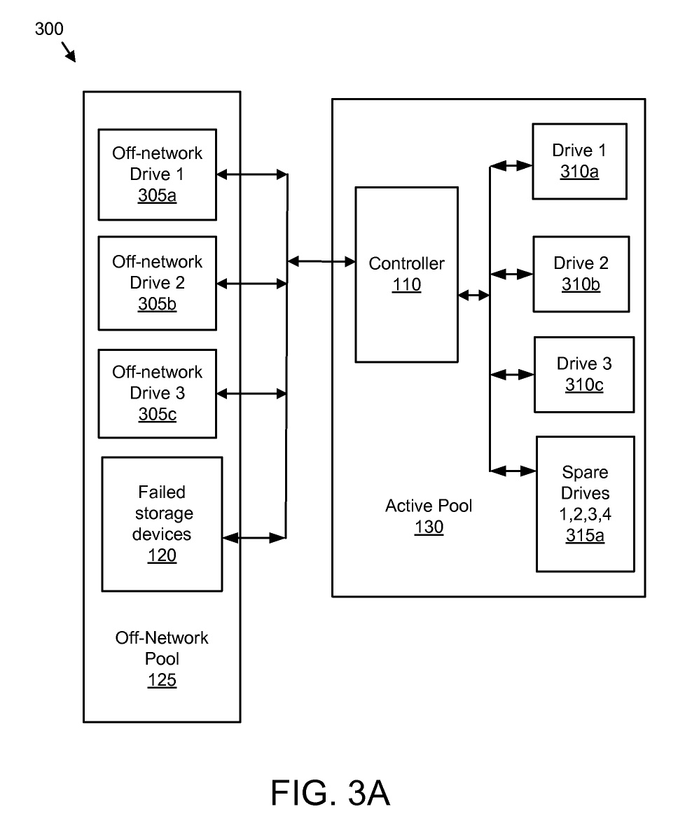

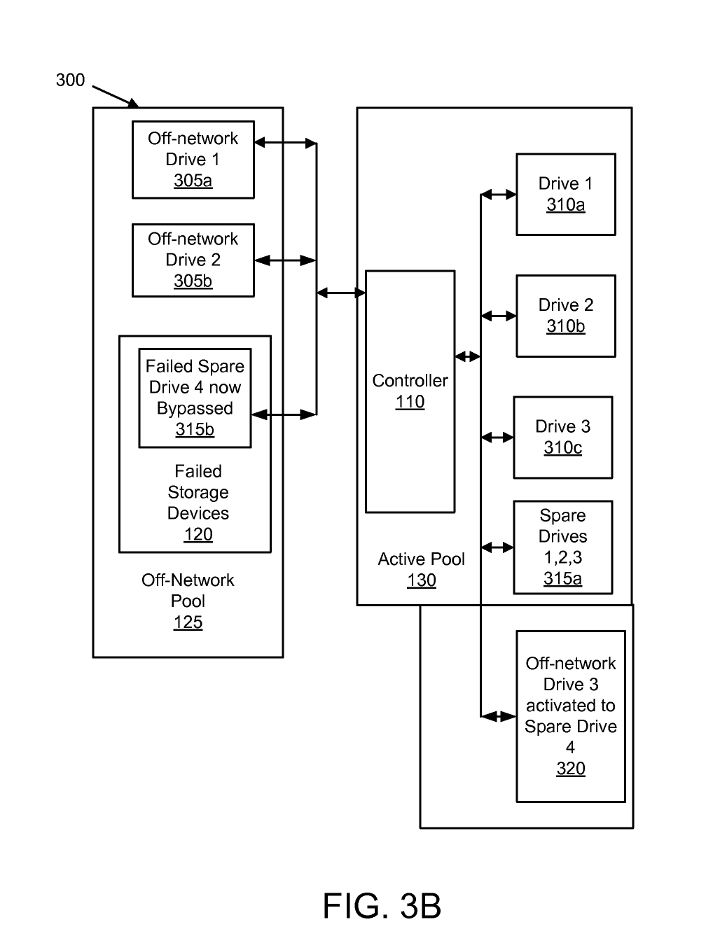

FIG. 3A depicts a schematic block diagram illustrating one embodiment of a Switched Drive Network 300 of the present invention. The description of the switched drive network 300 refers to the elements presented above with respect to the operation of the described System Reliability Apparatus 200 and elements of FIGS. 2 and 1, like number referring to like elements. The switched drive network 300 is comprised of an off-network pool 125 and an active pool 130. The off-network pool 125 has a logically fenced area for storage devices 120 and an off-network array of storage devices 105; the off-network array of storage devices comprising off-network drive 1, 305a; off-network drive 2, 305b; and off-network drive 3, 305c. The active pool 130 has a controller 110 and an array of storage devices 115; the array of storage devices 115 comprising drive 1, 310a; drive 2, 310b; drive, 3 310c; and spares drives 1, 2, 3, and 4, 315a.

Although for simplicity, one off-network pool 125; one active pool 130; one logically fenced area for storage devices 120; one off-network drive 1, 305a; one off-network drive 2, 305b; one off-network drive 3, 305c; one controller 110; one drive 1, 310a; one drive 2, 310b; one drive, 3 310c; and spares drives 1, 2, 3, and 4, 315a are shown, any number of off-network pools 125, active pools 130, logically fenced storage devices 120, off-network drives 305, controllers 110, drives 310, and spare drives 315 may be employed.

FIG. 3B depicts a schematic block diagram illustrating one embodiment of a switched drive network 300 of the present invention. The switched drive network 300 maintains system reliability by logically repositioning storage devices. For example, the detection module 205 may detect a hardware failure such as a spindle motor problem for spare drive 315b. The repositioning module 210 may reposition the failed spare drive 315b to the logically fenced storage devices 120 and the off-network drive 3, 305c to spare drive 4, 320.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

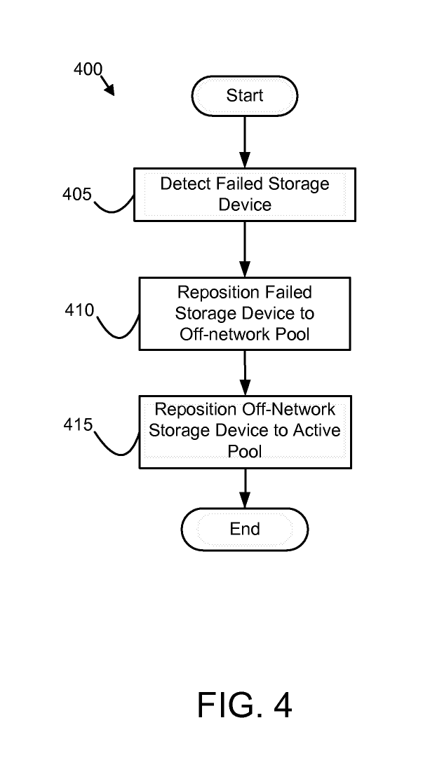

FIG. 4 depicts schematic flow chart diagram illustrating one embodiment of a switched drive method 400 of the present invention. The method 400 substantially includes the steps to carry out the functions presented above with respect to the operation of the switched drive networks 300, described apparatus 200, and the storage system 100 of FIGS. 3B, 3A, 2 and 1 respectively. The description of method 400 refers to elements of FIGS. 1-3, like numbering referring to like elements. In one embodiment, the method 400 is implemented with a computer program product comprising a computer readable medium having a computer readable program. The computer readable program may be executed by the controller 110.

The method 400 begins and in an embodiment the detection module 205 detects 405 a failed storage device. Detecting the failed storage device may be accomplished by a utilizing a computer program executing on the controller 110 that has met one of several criteria including slow response time, long input/output times, failed initialization, failed “health check”, and exhausted read/write retries.

In one embodiment, the failed storage device can be detected because it is not responding to commands. For example, the controller 110 may detect 405 a failed storage device 315b because it will not respond to a request to store data.

The repositioning module 320 repositions 410 the failed storage device to the logically fenced area for storage devices 120. For example, the repositioning module 210 may logically reposition the failed storage device 315b to the logically fenced area for storage devices 120 because its response time exceeds preset limits.

The repositioning module 210 repositions 415 an off-network storage device to the active pool 130. For example, the repositioning module 210 may logically reposition an off-network drive 3, 305c to the active pool 130 as a spare drive 4, 320 because there was a need for additional storage. In one embodiment, the repositioning module 210 may replace failed storage devices from the active pool 130 with off-network storage devices on a one for one basis.

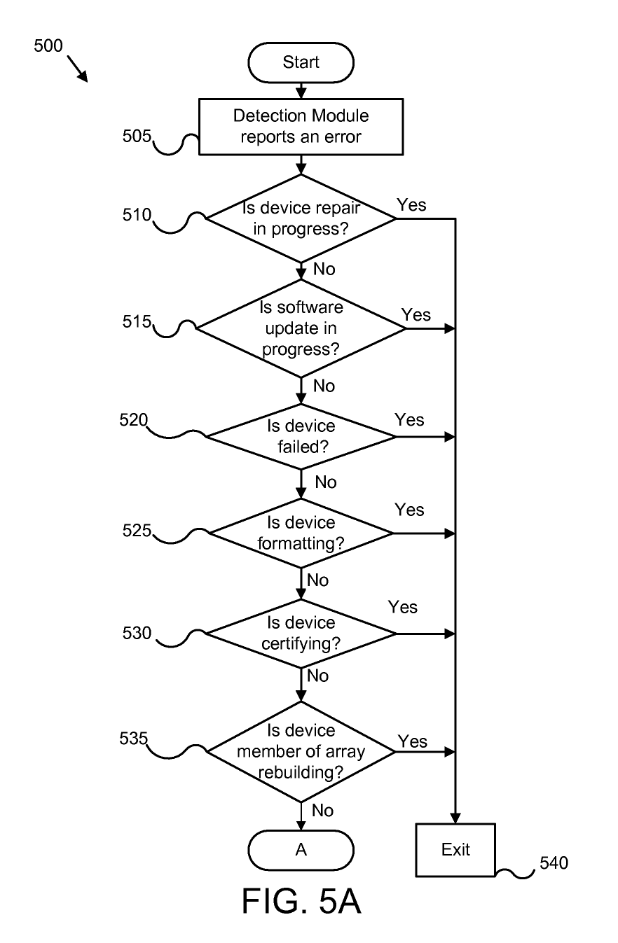

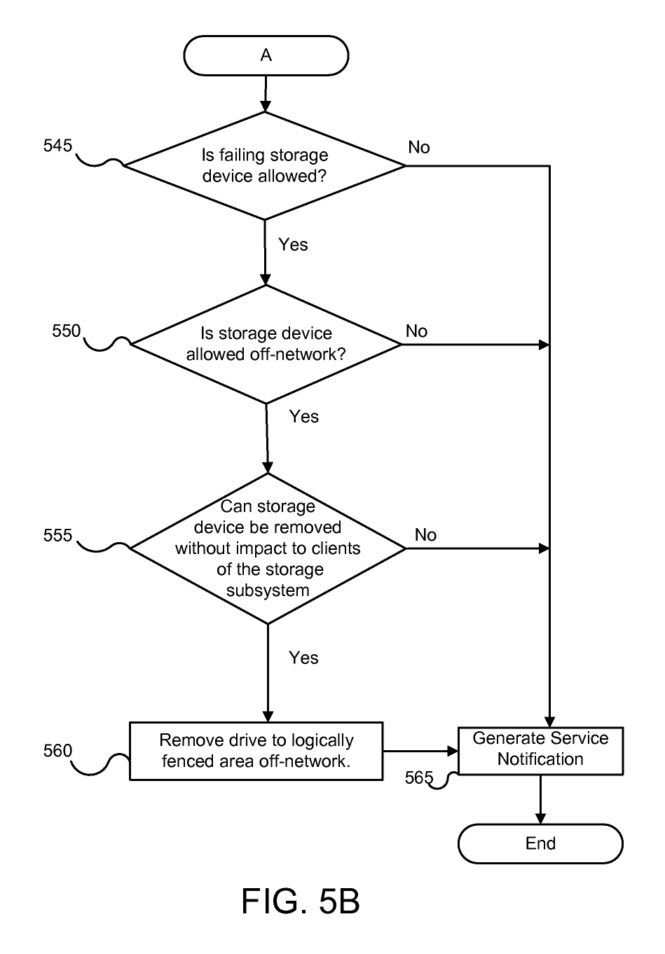

FIG. 5A and 5B depicts a schematic flow chart diagram illustrating one embodiment of a controller communication method of the present invention. The method 500 substantially includes the steps to carry out the functions presented above with respect to the steps of 405, and 410 of the described method 400. The description of method 500 refers to elements of FIGS. 1-4, like numbering referring to like elements. In one embodiment, the method 500 is implemented with a computer program product comprising a computer readable medium having a computer readable program. The computer readable program may be executed by the controller 110.

The method 500 begins, and in an embodiment, the detection module 205 reports 505 an error of a storage device. For example, the detection module 205 may determine that the storage device 315b is slow in responding to commands and report the device as failing.

In one embodiment, the detection module 205 determines 510 if a repair to the storage device 315b is in progress. For example, the storage device 315b may be performing self correcting steps to remedy the slow response times and thus have repairs in progress. If the detection module 205 determines that a device repair is in progress, the detection module 205 ceases further checks of intermediate operations and exits 540 the method.

If the detection module 205 determines that a storage device repair is not in progress, the method 500 continues and the detection module 205 determines 515 if software for the storage device is updating. For example, the detection module 205 may determine 515 a software to better logically partition storage devices is updating. If the detection module 205 determines 515 that software for the storage device is updating, the detection module 205 ceases further checks of intermediate operations and exits 540 the method.

If the detection module 205 determines that software for the storage system is not updating, the method continues and the detection module 205 determines 520 if the storage device is failed and has not yet been logically moved to the partitioned area. For example, the storage device may have previously been failed a “health check”. If the detection module 205 determines 520 that the storage device is failed, the detection module 205 ceases further checks of intermediate operations and exits 540 the method.

If the detection module 205 determines 520 that the storage device is not failed, the method continues and the detection module 205 determines 525 if the storage device is formatting. For example, the storage device may be formatting a hard-drive to prepare it for reading and writing data. If the detection module 205 determines 525 that the storage device is formatting, the detection module 205 ceases further checks of intermediate operations and exits 540 the method.

If the detection module 205 determines 525 that the storage device is not formatting, the method 500 continues and the detection module 205 determines 530 if the storage device is certifying. For example, the storage device may be certifying that a hard-drive is compatible to read and write data from the controller. If the detection module 205 determines 530 that the storage device is certifying, the detection module 205 ceases further checks of intermediate operations and exits 540 the method.

If the detection module 205 determines 530 that the storage device is not certifying, the method 500 continues and the detection module 205 determines 535 if the array is rebuilding data. For example, the storage device may be supplying data so that the rebuilding module 215 can rebuild the array. If the detection module 205 determines 535 that the array is rebuilding, the detection module 205 ceases further checks of intermediate operations and exits 540 the method.

If the detection module 205 determines 535 that the array is not rebuilding, the method 500 continues. For example, the storage device may have completed the data transfer to allow the rebuilding module 215 to rebuild the array. If the detection module 205 determines 535 that the array is not rebuilding, the method 500 continues.

Continuing the method 500 with FIG. 5B, and the repositioning module 210 determines 545 if failing the storage device is allowed. For example, a storage device may be the last available unit and so it cannot be logically moved while waiting for a service technician. If the repositioning module 210 determines 545 that failing the storage device is not allowed, the repositioning module 210 ceases further checks of intermediate operations and generates 565 a service notification.

If the repositioning module 210 determines 545 if failing the storage device is allowed, the method 500 continues and the repositioning module 210 determines 550 if the storage device is allowed to be off-network. For example, the storage device may have mission critical data that requires the storage device to stay in the array of storage devices 115 until the machine is serviced. If the repositioning module 210 determines 550 that the storage device is not allowed off-network, the repositioning module 210 ceases further checks of intermediate operations and generates 565 a service notification.

If the repositioning module 210 determines 550 that the storage device is allowed off-network, the method 500 continues and the repositioning module 210 determines 555 if the failing storage device can be removed without impact to clients of the storage subsystem. For example, the repositioning module 210 may determine that the storage device is not responding to any commands and cannot be removed from the array. If the repositioning module 210 determines 555 that the failing storage device cannot be removed without impact to clients of the storage subsystem, the repositioning module 210 ceases further checks of intermediate operations and generates 565 a service notification.

If the repositioning module 210 determines 555 that the storage device can be removed successfully, the method 500 continues and the repositioning module logically moves 560 the failing storage device to a logically fenced area for failed storage devices 120. For example, the repositioning module 210 may determine that the failing storage meets all requirements such that the device can be moved logically. The storage device is moved logically to an off-network pool 125 and the repositioning module 210 generates 565 a service notification.

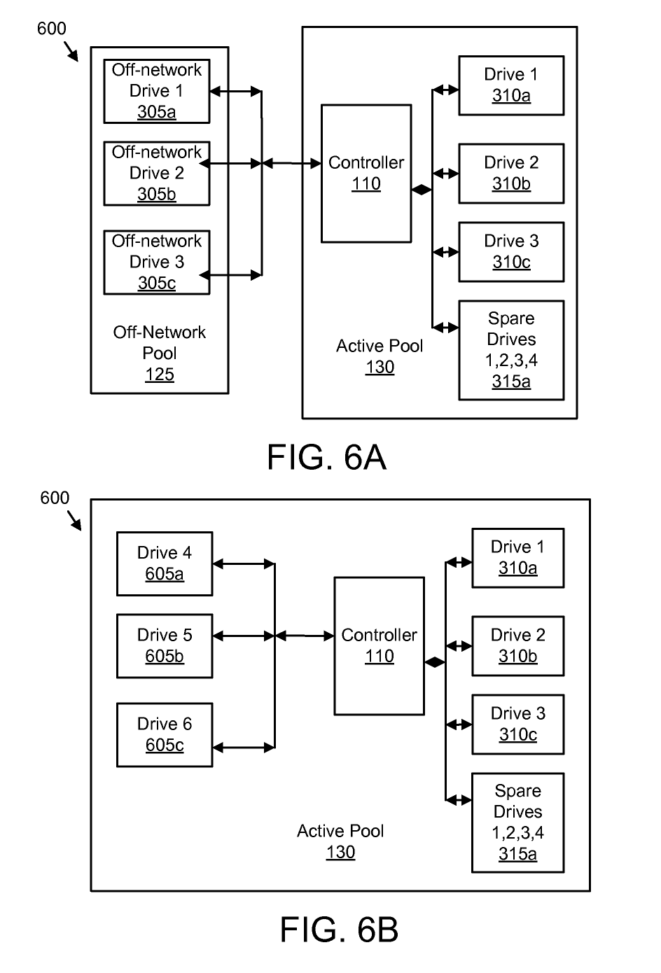

FIGS. 6A and 6B depicts schematic block diagrams illustrating one embodiment of a storage capacity upgrade 600 of the present invention. Storage capacity upgrade 600 is illustrated with an off-network pool 125 consisting of an off-network drive 1, 305a; an off-network drive 2, 305b; an off-network drive 3, 305c; an active pool 130 consisting of a controller 110; a drive 1, 310a; a drive 2, 310b; a drive 3, 310c; and spare drives 1, 2, 3, 4, 315a. The description of the storage capacity upgrade 600 refers to the elements presented above with respect to the operation of the described Controller Communication method 500, Switched drive method 400, Switched drive network 300, System Reliability Apparatus 200, Storage system 100 and elements of FIGS. 5, 4, 3,2 and 1, like number referring to like elements.

The detection module 205 detects the operable off-network pool storage devices can be logically repositioned as a capacity upgrade of the storage system. For example, the array of storage devices may no longer be under warranty. In one embodiment, the storage system may choose to convert the operable off network storage devices to a capacity upgrade at the conclusion of the warranty period.

The repositioning module 210, repositions the operable off-network storage devices to the active pool to complete the capacity upgrade.

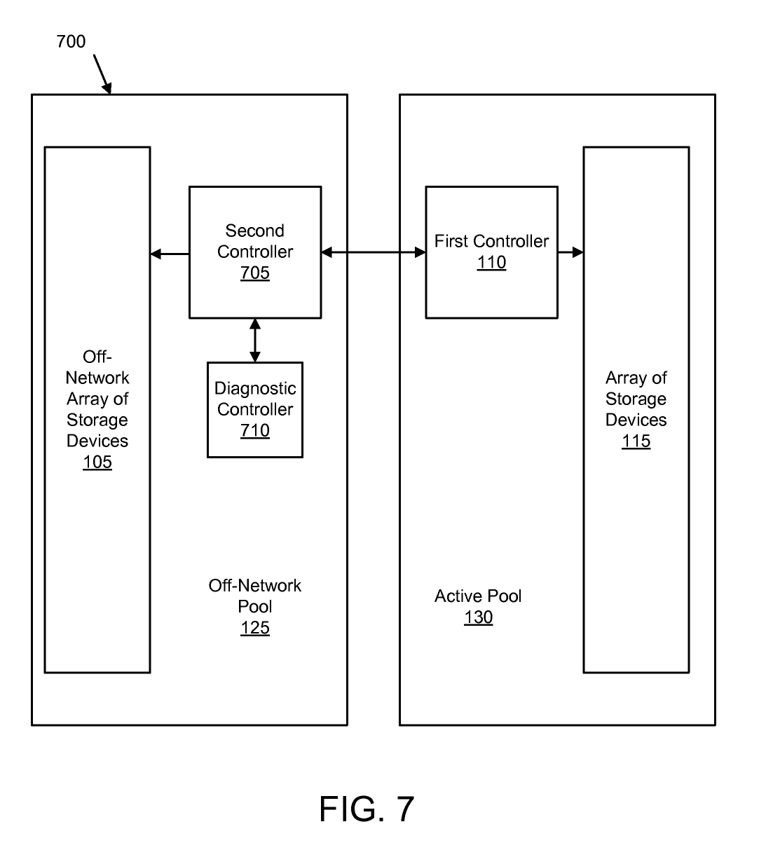

FIG. 7 depicts a schematic block diagram illustrating one embodiment of an off-network controller 700 of the present invention. The description of the off-network controller 700 refers to the elements presented above with respect to the operation of the described Storage Capacity Upgrade 600, Controller Communication method 500, Switched drive method 400, Switched drive network 300, System Reliability Apparatus 200, Storage system 100 and elements of FIGS. 6, 5, 4, 3, 2 and 1, like number referring to like elements.

The off-network array of storage devices 105 may be controlled by an independent second controller 705 that performs diagnostic tests on the off-network array of storage devices 105. For example, the first controller 110 may call for an off-network storage device to be logically repositioned to the active pool. The second controller 705 may activate a diagnostic controller 710 to test an off-network storage device to assure that it is working properly prior to logically repositioning it to the active pool.

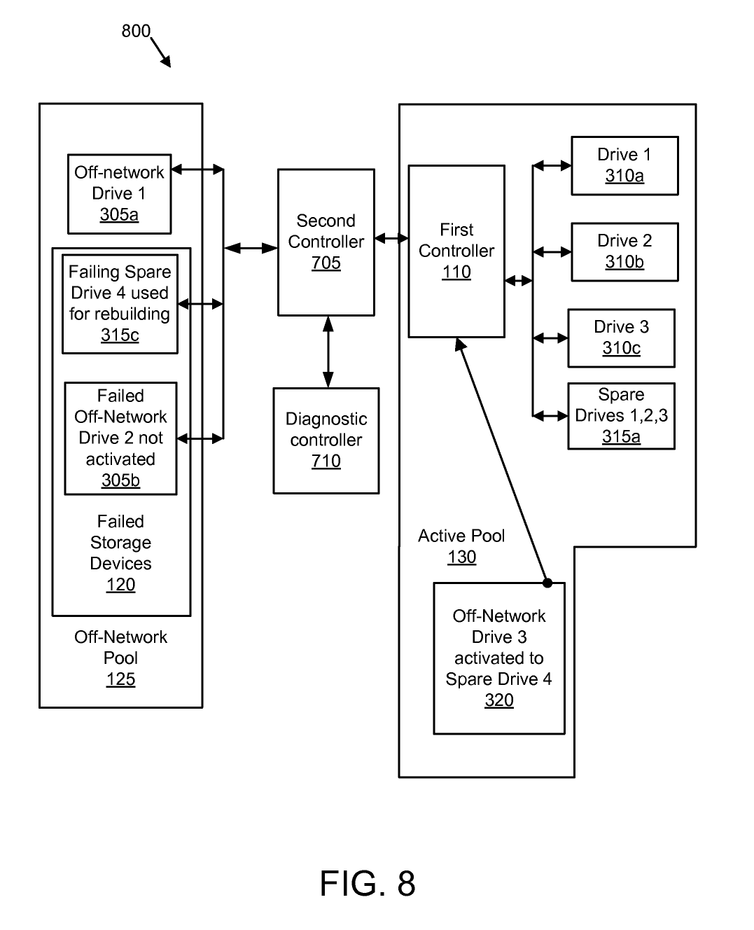

FIG. 8 depicts a schematic block diagram illustrating one embodiment of a pre-activation diagnostic controller process 800 of the present invention. The description of the pre-activation diagnostic controller process 800 refers to the elements presented above with respect to the operation of the described Off-network controller 700, Storage Capacity Upgrade 600, Controller Communication method 500, Switched drive method 400, Switched drive network 300, System Reliability Apparatus 200, Storage system 100 and elements of FIGS. 7, 6, 5, 4, 3, 2 and 1, like number referring to like elements.

In an embodiment, the detection module 205 of the first controller 110 detects a failing spare drive 4, 315c. The repositioning module 210 of the first controller 110 logically moves the failing spare drive 4, 315c; to the logically fenced area for failing storage devices 120 of the off-network pool 125. The second controller 705 prepares the off-network drive 2, 305b; to be repositioned to the active pool 130. The diagnostic controller 710 performs tests and fails the off-network drive 2, 305b. The second controller 705 prepares off-network drive 3, 305c to be repositioned to the active pool 130. The diagnostic controller performs tests and approves the repositioning module 210 to reposition the off-network drive 3, 305c to spare drive 4, 320.

In another embodiment, the rebuilding module 215 rebuilds the data from the failing spare drive 4, 315c to the off-network drive 3, 305c using the off-network controller 705. The failing spare drive 4, 315c may have critical data that a redundant array or independent drives (RAID) needs to operate. Using the failing spare drive 4, 315c to rebuild the data to off-network drive 3, 305c may reduce the time that the critical data is unavailable to the active pool 130 which in turn reduces the exposure to secondary failures while the critical data is unavailable.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for improving storage system reliability by managing switched drive: networks, the apparatus comprising:
an off-network pool of storage devices that is configured to be logically isolated from an array of storage devices;
a detection module comprising a computer readable program stored on a tangible storage device executing on a controller and configured to detect a failed storage device in the array of storage devices; and
a repositioning module comprising a computer readable program stored on a tangible storage device executing on a controller and configured to logically reposition the failed storage device from the array, if a remedial operation is not in progress, to the off-network pool wherein the failed storage device is not accessible to the array and data of the failed storage device is accessible to the controller; and logically reposition a replacement storage device from the off-network pool to the array.

2. The apparatus of claim 1, further comprising a rebuilding module comprising a computer readable program stored on the tangible storage device, executing on the controller, and configured to rebuild the data from the failed storage device wherein the controller initiates rewriting the data to the replacement storage device.

3. The apparatus of claim 1, wherein the off-network pool of storage devices is initially installed, configured, tested, and logically off the network from the storage system.

4. The apparatus of claim 3, wherein the operable off-network pool storage devices can be logically repositioned as a capacity upgrade of the storage system.

5. The apparatus of claim 3, wherein the off-network array of storage devices may be controlled by an independent off-network controller that performs diagnostic tests on the off-network array of storage devices.

6. The apparatus of claim 3, wherein the purpose of storage devices can be modified.

7. The apparatus of claim 1, wherein the detection module is further configured to detect failing storage devices

8. The apparatus of claim 7, wherein the detection module is further configured to:
report an error of a storage device;
determine if a repair to the storage device is in progress;
determine if software for the storage device is updating;
determine if the storage device failed;
determine if the storage device is formatting;
determine if the storage device is certifying; and
determine if the array is rebuilding.

9. The apparatus of claim 1, wherein the repositioning module is further configured to:
determine if failing the storage device is allowed;
determine if the storage device is allowed to be off network;
determine if the failing storage device can be removed without impact to clients of the storage subsystem.

10. The apparatus of claim 1, wherein if the failing storage device cannot be removed successfully, the repositioning module is further configured to determine if a failing operation results in a concurrent operation.

11. The apparatus of claim 1, wherein the failing storage device is logically moved to a logically fenced area for failing storage devices.

12. The apparatus of claim 2, wherein the rebuilding module is further configured to rebuild data from the failing storage devices using the off-network controller.

13. A computer program product comprising a computer useable medium having a computer readable program, wherein the computer readable program when executed on a computer causes the computer to:
detect a failed storage device in an array of storage devices; and
reposition the failed storage device from the array, if a remedial operation is not in progress, to a logically fenced area for failed storage devices in an off-network pool of storage devices that is configured to be logically isolated from the array of storage devices, wherein the failed storage device is not accessible to the array and data of the failed storage device is accessible to the controller; and logically reposition a replacement storage device from the off-network pool to the array.
rebuild the data from the failed storage device wherein the controller initiates rewriting the data to the replacement storage device.

14. The computer program product of claim 13, wherein the computer readable program is further configured to cause the computer to:
report an error of a storage device;
determine if a repair to the storage device is in progress;
determine if software for the storage device is updating;
determine if the storage device failed;
determine if the storage device is formatting;
determine if the storage device is certifying; and
determine if the array is rebuilding.

15. The computer program product of claim 14, wherein the computer readable program is further configured to cause the computer to:
determine if failing the storage device is allowed; and
determine if the storage device is allowed to be off-network.

16. A system for improving system reliability by managing switched drive networks, the system comprising:
an off-network pool comprising a plurality of storage devices;
an active pool comprising an array of storage devices and a controller in communication with the off-network pool and the array, the controller comprising
a detection module comprising a computer readable program executing on the controller and configured to detect a failed storage device in the array of storage devices;
a repositioning module comprising a computer readable program executing on the controller and configured to logically reposition the failed storage device from the array, if a remedial operation is not in progress, to the off-network pool wherein the failed storage device is not accessible to the array and the data of the failed storage device is accessible to the controller; and logically reposition a replacement storage device from the off-network pool to the array; and
a rebuilding module comprising a computer readable program executing on a controller and configured to rebuild the data from the failed storage device wherein the controller initiates rewriting the data to the replacement storage device.

17. The system of claim 16, wherein the off-network pool of storage devices is initially installed, configured, tested and logically bypassed from the system network.

18. The system of claim 16, the detection module is further configured to:
report an error of a storage device;
determine if a repair to the storage device is in progress;
determine if software for the storage system is updating;
determine if the storage device failed;
determine if the storage device is formatting;
determine if the storage device is certifying; and
determine if the array is rebuilding.

19. The system of claim 16, wherein the repositioning module is further configured to:
determine if failing the storage device is allowed; and
determine if the storage device is allowed to be off-network.

20. A method for deploying computer infrastructure, comprising integrating computer readable program into a computing system, wherein the program in combination with the computing system is capable of performing the following:
detecting a failed storage device in an array of storage devices; and
reporting an error of the storage device;
determining if a repair to the storage device is in progress;
determining if software for a storage device is updating;
determining if the storage device failed;
determining if the storage device is formatting;
determining if the storage device is certifying;
determining if the array is rebuilding;
determining if failing a storage device is allowed;
determining if the storage device is allowed to be off network;
repositioning a detected storage device to a logically fenced area for failed storage devices in an off-network pool of storage devices; and
rebuilding the data from the failed storage device wherein the controller initiates rewriting the data to a replacement storage device;
